(19) United States
(12) Patent Application Publication
(10) Pub. No.: US 2022/0253920 A1
(43) Pub. Date: Aug. 11, 2022

(54) APPARATUS FOR PROCESSING ITEM SALES INFORMATION AND METHOD THEREOF

(71) Applicant: Coupang Corp., Seoul (KR)

(72) Inventors: Seung Ho Jeong, Seoul (KR); Chun Kwon Park, Seoul (KR); Byeong Yong Lee, Seoul (KR); Duck Hyeon Yoo, Seoul (KR); Soo Kyung Jun, Seoul (KR); Nicolas Maxence Patrick Marie Daudin, Seoul (KR); Catherine Chang, Seoul (KR)

(21) Appl. No.: 17/196,915

(22) Filed: Mar. 9, 2021

(30) Foreign Application Priority Data
Feb. 5, 2021 (KR) 10-2021-0016731

(51) Int. Cl. G06Q 30/06; G06Q 20/12; G06F 3/0484

(52) U.S. Cl. CPC G06Q 30/0641; G06F 3/0484; G06Q 20/12; G06Q 30/0607

(57) ABSTRACT

Provided is a method of processing item sales information by a terminal, the method including providing a user with a first page including first content related to item information, obtaining a first input for selecting a purchase of an item on the first page, providing a first payment user interface (UI) for purchasing the item while maintaining at least a part of the first content, and processing a transaction related to the purchase of the item based on a second input to the first payment UI and payment information corresponding to the user.

### BACKGROUND

### Technical Field

The present disclosure relates to relates to an apparatus and method for processing item sales information. More specifically, the present disclosure relates to an apparatus and a method thereof which obtains a first input for selecting a purchase of an item on a first page including first content related to item information, provides a user interface (UI) for purchasing the item while maintaining at least a part of the first content, and processes a transaction related to the purchase of the item based on a second input to a first payment UI and payment information corresponding to a user.

### Description of the Related Art

With the development of electronic technology, e-commerce has grown as a field of shopping. Customers can purchase items online without going to a shopping mall or market in person, and items purchased online are delivered to the delivery address requested by the customer.

In the process of e-commerce, a user may shop for an item on sale through a terminal connected to the Internet such as a computer, and transmit an intention to purchase the item to the seller. In this case, a transaction related to the purchase of an item may be processed using a payment method input by a user such as a credit card number and password.

A seller who has received an intention to purchase an item may request information necessary for the sale and delivery of the item, such as a payment method and delivery address, from the user. However, in the case of requesting information such as payment method and delivery address each time an item is traded, such information must be repeatedly entered even if the user proceeds with a payment using the same payment method as before and ships the item to the same delivery address as before. Therefore, there is an inconvenience in that the user must repeatedly input the same information, and there may also be a risk of information leakage.

Furthermore, in the case of a change from the page where the user was shopping to a separate page for transaction processing such as receiving information such as payment method and delivery address, the screen where the user was shopping is not maintained, so it is difficult to induce the user to purchase the item. In addition, the user may feel inconvenient to proceed with a payment through a separate page. Moreover, it takes a longer time and consumes more resources than transactions processed on the same page.

In connection, prior documents such as KR20150083149A and KR101712765B1 may be referred.

### SUMMARY

### Technical Goals

An aspect of the present disclosure is to provide an apparatus and method which obtains a first input for selecting a purchase of an item on a first page including first content related to item information, provides a first payment UI for purchasing the item while maintaining at least some of the first content, and processes a transaction related to the item purchase based on a second input to the first payment UI and payment information corresponding to the user.

The technical aspect to be achieved by the present disclosure is not limited to those described above, and other technical aspects may be inferred from the following example embodiments.

### Technical Solutions

According to an aspect, there is provided a method of processing item sales information by a terminal, the method including providing a user with a first page including first content related to item information, obtaining a first input for selecting a purchase of an item on the first page, providing a first payment user interface (UI) for purchasing the item while maintaining at least a part of the first content, and processing a transaction related to the purchase of the item based on a second input to the first payment UI and payment information corresponding to the user.

The providing of the first payment UI may include providing the first payment UI when the user information and the item information corresponding to the first input correspond to a preset condition.

The method may further include providing a second payment UI for purchasing the item on a second page switched from the first page when the user information and the item information corresponding to the first input do not correspond to the preset condition.

The preset condition may include at least one of when the item is not subject to installment payment, when the user's adult verification is not requested to purchase the item, and when the user's tax declaration is not requested to purchase the item.

The first payment UI may include at least one of a UI for inputting a payment method, a UI for inputting a delivery address, and a UI for processing a payment.

The first input and an input corresponding to the UI for processing a payment may be different types of inputs.

The second input may include at least one of an input for setting a payment method, an input for setting a delivery address, and an input for processing a payment, when at least one of the input for setting the payment method and the input for setting the delivery address is received through the first type of input, at least one of the payment method setting and the delivery address setting may be changed on the first page, and, when at least one of the input for setting the payment method and the input for setting the delivery address is received through the second type of input, at least one of the payment method setting and the delivery address setting may be changed on the second page switched from the first page.

The method may further include providing a UI for canceling the payment process for a preset time when the second input includes an input for processing a payment.

A request for shipment of the item may be provided to a first server in accordance with processing of the transaction.

The payment information corresponding to the user may include previously stored payment method information.

The processing of the transaction related to the purchase of the item may include, when the second input does not include an input for setting a payment method, processing the transaction related to the item based on the previously stored payment method, and, when the second input includes an input for setting the payment method, processing the transaction related to the item based on the payment method set by the second input.

The method may further include, when the processing of the transaction fails in relation to the payment method, displaying a list of the previously stored payment method information, and, when receiving an input corresponding to a specific payment method included in the list of previously stored payment method information, processing the transaction based on the specific payment method.

The method may further include providing a second payment UI for purchasing the item on the second page switched from the first page if the second input includes at least one of an input for setting a payment method and an input for setting a delivery address.

The method may further include, when obtaining a third input for selecting the item, providing a second payment UI for purchasing the item on a third page switched from the first page in response to the third input. The third page may include information on or regarding the item list selected by the user, and payment for at least one in the item list may be performed according to an input corresponding to the second payment UI for purchasing the item.

At least one of the first input and the second input may include purchase quantity information for the item.

According to another aspect, there is also provided a terminal processing item sales information, the terminal including a transceiver, a memory in which instructions are stored, and a processor, wherein the processor is connected to the transceiver and the memory and configured to provide a first page including first content related to item information to a user, obtain a first input for selecting a purchase of an item on the first page, provide a first payment UI for purchasing the item while maintaining at least a part of the first content, and process a transaction related to the purchase of the item based on a second input to the first payment UI and payment information corresponding to the user.

Details of other example embodiments are included in the detailed description and drawings.

### Effects

According to the present disclosure, an apparatus and a method for processing item sales information provides a UI for purchasing an item while maintaining at least a part of content related to the item information, thereby promoting the user's convenience in purchasing an item, encouraging item purchase of the user, and saving time and resources.

Effects of the present disclosure are not limited to the effects mentioned above, and other effects not mentioned will be clearly understood by those skilled in the art from the description of the claims.

### BRIEF DESCRIPTION OF THE DRAWINGS

FIG. 1 is a schematic configuration diagram illustrating an item sales information processing system according to an example embodiment.

FIG. 2 is a flowchart illustrating a method of processing information by a terminal in a system for processing item sales information according to an example embodiment.

FIG. 3 is an exemplary diagram illustrating an operation of a terminal providing a first page to a user and obtaining a first input on the first page according to an example embodiment.

FIG. 4 is an exemplary diagram illustrating an operation of a terminal providing a first payment UI while maintaining at least a part of the first content according to an example embodiment.

FIG. 5 is an exemplary diagram illustrating an operation of a terminal providing a second payment UI on a second page switched from a first page according to an example embodiment.

FIG. 6 is an exemplary diagram illustrating an operation of a terminal providing a cancellation UI for canceling an input for a payment process according to an example embodiment.

FIG. 7 is an exemplary diagram illustrating an operation of displaying a list of previously stored payment method information when a terminal fails to process a transaction related to a payment method according to an example embodiment.

FIG. 8 is an exemplary diagram of a configuration of a terminal for processing item sales information according to an example embodiment.

### DETAILED DESCRIPTION

Terms used in the embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

Throughout the specification, when it is stated that a part “includes” a certain component, it means that other components may be further included, and it does not preclude other components, unless otherwise stated. In addition, terms such as “-unit”, “-module” described in the specification mean a unit for performing at least one function or operation, which may be implemented as hardware or software, or as a combination of hardware and software.

Throughout the specification, expression “at least one of a, b, and c” may include ‘a only’, ‘b only’, ‘c only’, ‘a and b’, ‘a and c’, ‘b and c’, or ‘all of a, b, and c’.

The “terminal” mentioned below may be implemented as a computer or a portable terminal that can access a server or other terminal through a network. Here, the computer includes, for example, a notebook, a desktop, a laptop, and the like, equipped with a web browser, and the portable terminal is, for example, a wireless communication device that guarantees portability and mobility, which may include all kinds of handheld-based wireless communication device including communication-based terminals such as IMT (International Mobile Telecommunication), CDMA (Code Division Multiple Access), W-CDMA (W-Code Division Multiple Access), LTE (Long Term Evolution), smartphones, tablet PCs, or the like.

Example embodiments of the present disclosure will be described in detail with reference to the accompanying drawings so that those skilled in the art may easily implement the present disclosure. However, the present disclosure may be implemented in various different forms and is not limited to the embodiments described herein.

Hereinafter, example embodiments of the present disclosure are described in detail with reference to the accompanying drawings.

In describing the example embodiments, descriptions of technical contents well-known in the technical field to which the present disclosure pertains and are not directly related to the present disclosure will be omitted. This aims to omit unnecessary description so as to avoid obscuring and more clearly convey the gist of the present disclosure.

For the same reason, some elements are exaggerated, omitted, or simplified in the drawings. In addition, the size of each element does not fully reflect the actual size. The same reference numerals are assigned to the same or corresponding elements in each drawing.

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present disclosure will only be defined by the appended claims. Like reference numerals refer to like elements throughout the specification.

It will be understood that each block of the flowcharts, and combinations of blocks in the flowcharts, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions described in the block(s) of flowcharts. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function described in the block(s) of flowcharts. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions described in the block(s) of flowcharts.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

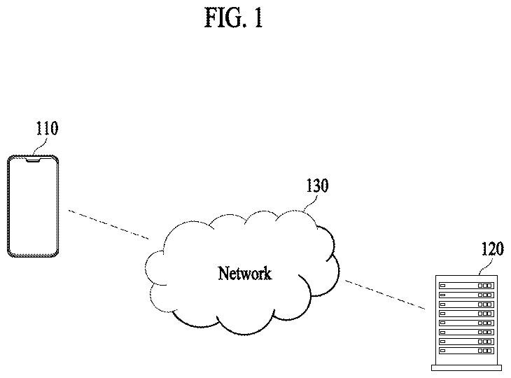

FIG. 1 is a schematic configuration diagram illustrating an item sales information processing system according to an example embodiment.

According to various example embodiments, the item sales information processing system 100 may include a terminal 110 and an electronic device 120. According to an example embodiment, the item sales information processing system 100 may further include at least one of a first server and a second server. According to an example embodiment, the item sales information processing system 100 may further include a network 130 supporting transmission and reception of information between at least some of the terminal 110, the electronic device 120, the first server, and the second server.

Each of the terminal 110, the electronic device 120, the first server, and the second server may include a transceiver, a memory, and a processor. In addition, each of the terminal 110, the electronic device 120, the first server, and the second server means a unit that processes at least one function or operation, which can be implemented by hardware or software, or a combination of hardware and software. Meanwhile, in the overall example embodiments, the terminal 110, the electronic device 120, the first server, and the second server are referred to as separate devices or servers, but these may be logically divided structures and implemented as separate functions in a single server.

According to an example embodiment, the terminal 110, the electronic device 120, the first server, and the second server may include a plurality of computer systems implemented as network servers or computer software. For example, at least some of the terminal 110, the electronic device 120, the first server, and the second server may refer to a computer system and computer software connected to a lower level device capable of communicating with another network server through a computer network such as an intranet or the Internet to receives a request to perform a task, performs the task, and provides a result of the task. In addition, at least some of the terminal 110, the electronic device 120, the first server, and the second server can be understood in a broad concept including a series of application programs that can operate on a network server and various databases built therein. For example, at least some of the terminal 110, the electronic device 120, the first server, and the second server may be implemented using a network server program that is variously provided according to an operating system, such as DOS, Windows, Linux, UNIX, or MacOS.

The terminal 110 may provide various pieces of information by configuring a web page. Specifically, the terminal 110 may be a device that serves to provide item sales information to a user. The terminal 110 provides a first page including first content related to item information to a user, obtains a first input for selecting a purchase of an item on the first page, and provides a first payment user interface (UI) for purchasing an item while maintaining at least a part of the first content. The item information is information related to one or more items sold on an e-commerce website, and at least some of the one or more items may be items that can be delivered.

According to an example embodiment, the terminal 110 may receive the first page including the first content from the electronic device 120 and provide the user with it. In addition, the terminal 110 may transmit the obtained first input to the electronic device 120, and the first payment UI may be generated by the electronic device 120. In this case, the terminal 110 may perform only a role of providing the first payment UI received from the electronic device 120 instead of directly generating the first payment UI. However, this is only an example, and in some cases, the terminal 110 may directly generate and provide the first page, or may generate and provide the first payment UI.

Thereafter, the terminal 110 processes a transaction related to the purchase of the item based on a second input to the first payment UI and payment information corresponding to the user. The second input may be an input received from the user, and the payment information corresponding to the user may be information previously stored in the memory of the terminal 110 or a separate storage device.

In connection with transaction processing, the terminal 110 may transmit a request for payment of the item sales price to the second server. For example, the terminal 110 may request to the second server to transfer the payment amount and transmit payment information including the transfer details of the payment amount to the terminal 110. Furthermore, the terminal 110 may transmit a request to the first server to ship at least some of the items from the distribution center and prepare for delivery.

According to an example embodiment, the terminal 110 transmits the second input for the first payment UI to the electronic device 120, and the electronic device 120 may process a transaction related to the purchase of the item based on the second input for the first payment UI and payment information corresponding to the user. Alternatively, according to an example embodiment, the terminal 110 may receive payment information corresponding to the user from the electronic device 120 and process a transaction based on the second input and payment information. In this case, the payment information corresponding to the user may be previously stored information in the memory of the electronic device 120, a separate storage device, or a cloud server.

Further, as the terminal 110 processes the transaction, the electronic device 120 may transmit a request for payment of the item sales price to the second server, and may transmit a request for shipment and delivery of the item to the first server.

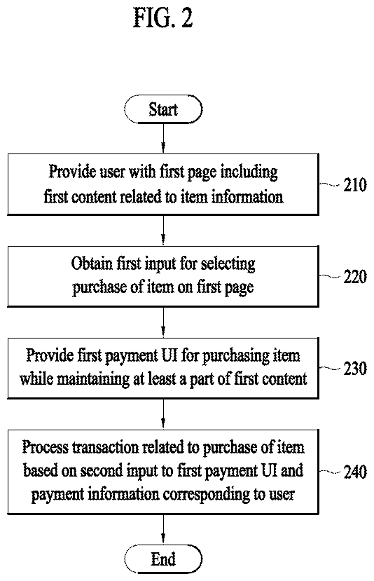

More details related to a method of processing item sales information in the terminal 110 will be described later in FIG. 2.

The electronic device 120 may be a device that manages an e-commerce website for selling items. The electronic device 120 may be a device that performs a role of providing item sales information to a user by transmitting and receiving various information to and from the terminal 110. Specifically, as described above, the electronic device 120 may perform operations such as providing the terminal 110 with the first page including the first content related to the item information, receiving the first input from the terminal 110, providing the terminal 110 with the first payment UI for purchasing an item, providing the terminal 110 with payment information corresponding to the user, or receiving the second input from the terminal to make a transaction.

Further, the electronic device 120 may transmit a request for payment of the item sales price to the second server, or may transmit a request for shipment and delivery of the item to the first server.

The first server may be a server managed by a distribution center for storage and delivery of items sold online. The first server, which receives a shipment and delivery request, may perform shipment of at least some of the items and prepare them for delivery. In relation to this, the first server may perform delivery to the address received from the terminal 110 or the electronic device 120. In addition, the first server manages the inventory of the distribution center, and can perform operations such as checking the work status of personnel related to shipment and delivery in order to complete item delivery within a certain time without omission. Moreover, depending on example embodiments, the second server may further check whether or not the item price has been paid.

The second server may be a server corresponding to the payment method. According to an example embodiment, the second server may correspond to a server managed by a specific financial institution. For example, the second server may correspond to a server managed by XX Bank.

According to an example embodiment, the payment method may correspond to a payment amount transfer based on an account managed by the second server. According to an example embodiment, the payment method may correspond to payment using a credit card issued by a corresponding card company by the second server. According to an example embodiment, the payment method may correspond to mobile phone payment. In addition, the payment method is not limited to a specific method and may include a wide range of payment methods.

Upon receiving the payment request from the terminal 110 or the electronic device 120, the second server may determine whether the account information included in the payment request is valid, and may determine whether the balance of the account corresponding to the account information is equal to or greater than the requested payment amount. According to the determination result, the second server may transfer the payment amount to the terminal 110 or the electronic device 120 or transmit payment failure information to the terminal 110 or the electronic device 120.

The network 130 may serve to connect the terminal 110 and the electronic device 120, a first server, a second server, or other external devices. For example, the network 130 may provide an access path so that the electronic device 120 is connected to the terminal 110 to transmit and receive packet data with the terminal 110.

A series of operations related to a method for processing item sales information according to various example embodiments may be implemented by a single physical device, or may be implemented in a manner in which a plurality of physical devices are organically combined. For example, some of the components included in the item sales information processing system 100 may be implemented by any one physical device, and the rest may be implemented by another physical device. For example, any one physical device may be implemented as a part of the terminal 110, and another physical device may also be implemented as a part of the electronic device 120, a part of the first server, or a part of the second server or other external devices. In some cases, each of the components included in the item sales information processing system is implemented to be distributed and arranged on different physical devices, and the distributed components are organically combined to perform the functions and operations of the item sales information processing system 100. For example, the terminal 110 of the present specification includes at least one sub-device, some operations described as being performed by the terminal 110 are performed by the first sub-device, and some other operations may be performed by the second sub-device.

FIG. 2 is a flowchart illustrating a method of processing information by a terminal in a system for processing item sales information according to an example embodiment.

Referring to FIG. 2, in operation 210, the terminal 110 according to an example embodiment provides a user with a first page including first content related to item information. As described above, the item information is information related to one or more items sold on an e-commerce website, and at least some of the one or more items may be items that can be delivered.

In operation 220, the terminal 110 obtains a first input for selecting a purchase of an item on the first page. The first input may be an input received from the user, and the first input may include various types of input such as a click using a mouse, a touch using a touch pad or a touch screen, voice recognition, and other electronic inputs. The first input is an input for selecting an item to be purchased by the user, and may be interpreted as an input indicating an intention to proceed with payment for the corresponding item.

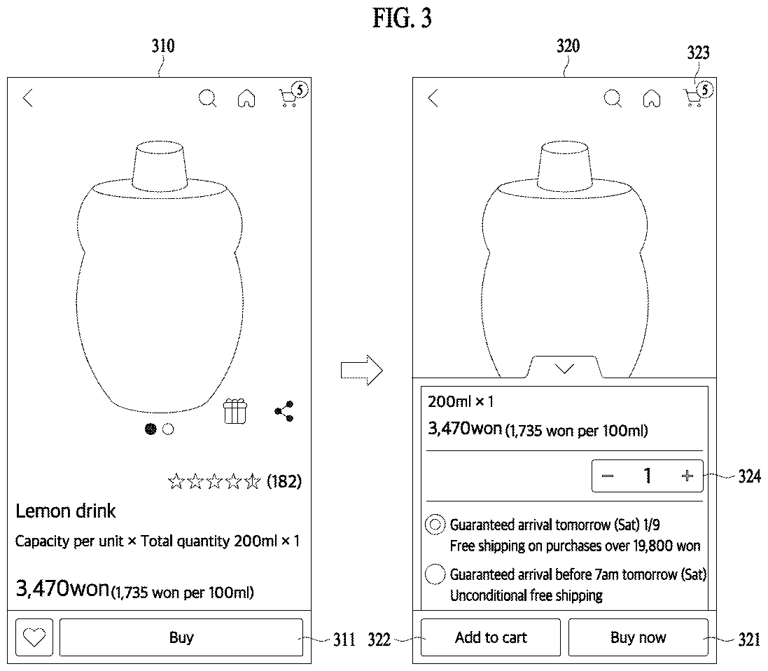

More detailed descriptions and examples related to the first page and the first input will be described later in FIG. 3.

In operation 230, the terminal 110 provides a first payment UI for purchasing an item while maintaining at least a part of the first content. The first payment UI may be a UI that is displayed on a part of the screen of the terminal 110 in order to maintain at least a part of the first content. The first payment UI may be displayed on the first page provided to the user (that is, it may be a UI displayed without a separate page change). Meanwhile, in an example embodiment, the first payment UI may be provided when the user has performed payment more than once using the set payment method and delivery address information, and otherwise, the payment may be performed through the second payment UI.

According to an example embodiment, the first payment UI is a UI that is displayed on a part of the screen of the terminal 110, and the interface is displayed more concisely than the second payment UI to be described later, or some of the contents displayed on the second payment UI may not be displayed on the first payment UI. For example, unlike the second payment UI, the first payment UI may not allow selecting to pay in installments when paying for an item, performing adult verification for item purchase, or performing a separate tax declaration for item purchase (for example, when buying gold or the like). In addition, for the item classification determined by the seller in an example embodiment, the payment may be made using the second payment UI instead of the payment using the first payment UI, and additional authentication information may be requested after the second payment UI. For example, the item classification determined by the seller may be an item with high liquidity.

The terminal 110 may provide a first payment UI when the user information and the item information corresponding to the first input correspond to a preset condition. According to an example embodiment, the preset condition may include at least some of the user's reliability and whether the item corresponding to the first input is an item directly sold on the e-commerce website. Specifically, the user's reliability is an index determined according to a preset criterion, and may be determined in consideration of, for example, the number of purchases, a purchase cancellation rate, and a payment failure rate in relation to the user's purchase history. In addition, the item directly sold on the e-commerce web site may correspond to an item registered and sold by an individual or company managing the e-commerce website, not items registered by a separate seller.

In addition, as described above, according to an example embodiment, the first payment UI (unlike the second payment UI) may not allow selecting to pay in installments when paying for an item, performing adult verification for item purchase, or performing a separate tax declaration for item purchase, and this may be reflected in preset conditions. That is, the preset condition may include at least one of whether the item is not subject to installment payment, whether the user's adult verification is requested to purchase the item, and whether the user's tax declaration is requested to purchase the item.

For example, if the payment price for an item is 50000 won or more and the website supports installment payments for items of 50000 won or more, the item is subject to installment payment. Then, the item information may not satisfy the condition of “whether the item is not subject to installment payment” set in advance. The corresponding condition may be set to prevent a situation in which the user cannot proceed with the installment payment because the display of selecting to pay in installments is not supported on the first payment UI even though the user intends to proceed with the installment payment.

Likewise, whether the user's adult verification is requested for the purchase of the item, and whether the user's tax declaration is requested for the purchase of the item may also be set to prevent a situation in which the user cannot proceed with the purchase of the desired item because the display of content related to adult verification or tax declaration is not supported in the first payment UI.

The first payment UI may include at least one of a UI for inputting a payment method, a UI for inputting a delivery address, and a UI for processing a payment. According to an example embodiment, the input corresponding to the UI for the payment process may be a different type of input from the first input. For example, the input corresponding to the UI for the payment process is an input by touching and dragging an icon in the form of a sliding bar displayed on a touch pad or touch screen (hereinafter, a slide input), whereas the first input is an input by touching or clicking with a mouse a purchase button.

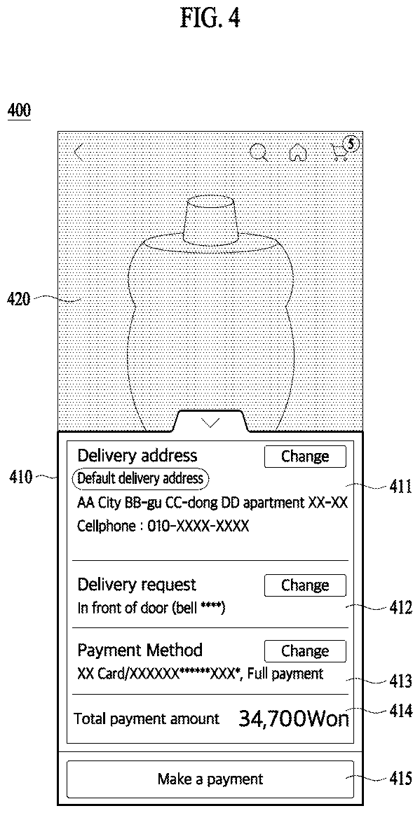

More details related to the first payment UI and an example of the first payment UI will be described later in FIG. 4.

When the user information and the item information corresponding to the first input do not correspond to a preset condition, the terminal 110 may provide a second payment UI for item purchase on the second page switched from the first page. Since the second payment UI is displayed on the switched second page, the first content may not be maintained on the screen where the second payment UI is provided. According to an example embodiment, the second payment UI may display the interface in more detail compared to the first payment UI, or it may further include content that is not displayed on the first payment UI.

In operation 240, the terminal 110 processes a transaction related to the purchase of the item based on the second input to the first payment UI and payment information corresponding to the user. As described above, the second input may be an input received from the user, and the payment information corresponding to the user may be information previously stored in the memory of the terminal 110 or a separate storage device.

The second input may include at least one of an input for setting a payment method, an input for setting a delivery address, and an input for proceeding with a payment. When the second input includes an input to proceed with a payment, the transaction related to the purchase of the item may include transmitting a request for payment of the item sales price to the second server. In relation to at least some of the items to be delivered, a request for shipment and delivery of the item may be transmitted to the first server according to processing of a transaction. In this case, the request for shipment and delivery of the item may be transmitted by the terminal 110 or may be transmitted by the electronic device 120.

The payment information corresponding to the user may include previously stored payment method information, and may further include previously stored delivery address information depending on example embodiments.

According to an example embodiment, when the second input does not include an input for setting a payment method, the terminal 110 may process the transaction related to the item based on a previously stored payment method. On the other hand, when the second input includes an input for setting a payment method, the transaction related to the item may be processed based on the payment method set by the second input. In other words, when the second input includes an input for setting a payment method, the terminal 110 may process the transaction according to the payment method included in the second input rather than a preset payment method. As described above, the second server may be a server that manages a payment method for processing a transaction.

When the item is an item to be delivered, and when the second input does not include an input for setting a delivery address, the terminal 110 processes the shipment and delivery request for the item based on the previously stored delivery address information, and when the second input includes an input for setting the delivery address, the terminal 110 may process the shipment and delivery request for the item based on delivery address information set by the second input. The delivery address information used by the terminal 110 to process the transaction may be transmitted to the first server, and the first server may perform shipment and delivery based on the received information.

According to an example embodiment, when the second input includes at least one of an input for setting a payment method and an input for setting a delivery address, the terminal 110 may provide the second payment UI for purchasing the item on the second page switched from the first page. For example, when the user does not proceed with a payment based on the payment method and delivery address information included in the previously stored payment information, but proceeds with the payment according to the changed payment method or proceeds with the shipment and delivery request according to the changed delivery address according to the second input, the second payment UI different from the first payment UI may be newly provided.

According to an example embodiment, when receiving at least one of an input for setting a payment method and an input for setting a delivery address through a first type of input, the terminal 110 may change at least one of a payment method setting and a delivery address setting on the first page. When at least one of the input for setting the payment method and the input for setting the delivery address is received through the second type of input, at least one of the payment method setting and the delivery address setting may be changed on the second page switched from the first page. In other words, depending on the type of input, the payment method or delivery address may be changed on the first page, or the payment method or delivery address may be changed on the second page switched from the first page.

In addition, according to an example embodiment, when a third input for selecting an item is obtained, the second payment UI for purchasing the item may be provided on the third page switched from the first page in response to the third input. The third input may correspond to an input indicating a purchase intention for the item, and the third page may include item list information selected by the user. As an example, the third input may include an input of including the item in the user's shopping cart.

At least one of the items included in the item list selected by the user may be paid according to an input corresponding to the second payment UI. Through this, the second payment UI can be used to collectively pay for the items included in the item list selected by the user. In this case, the condition of the item that can be collectively paid through the second payment UI among the items included in the item list selected by the user may be an item that can use the second payment UI. In the case of items in which the second payment UI is not available among items included in the item list selected by the user, payment may be performed through a payment UI provided on a separate page.

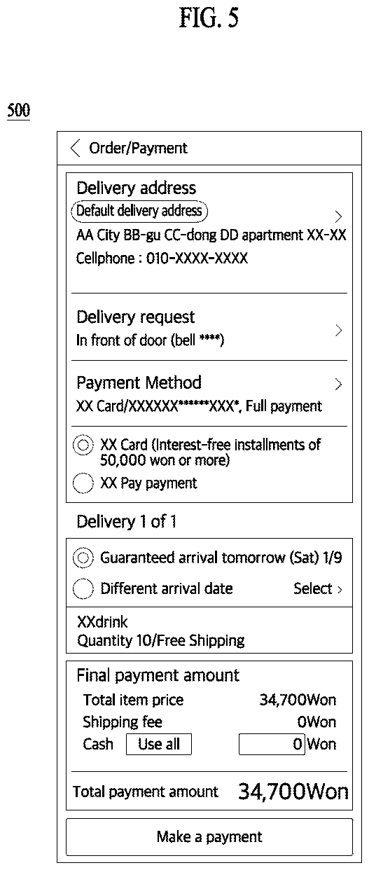

More details related to the second payment UI and an example of the second payment UI will be described later in FIG. 5.

According to an example embodiment, when the second input includes an input for payment process, the terminal 110 may provide a cancellation UI for canceling the input for payment process. The cancellation UI may be provided for a preset time. In the case of the first payment UI, there is a high probability that the user inputs payment due to an error or mistake, such as displayed on the first page. Accordingly, by providing a cancellation UI, the terminal 110 may provide the user with an opportunity to cancel the payment input.

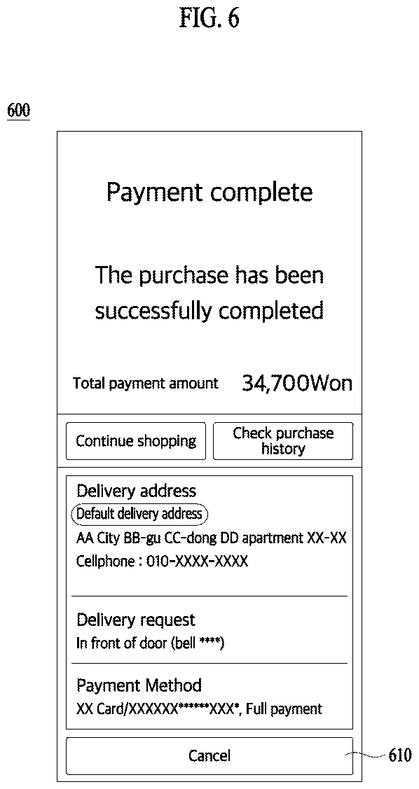

More details related to the cancellation UI and an example of the cancellation UI will be described later in FIG. 6.

FIG. 3 is an exemplary diagram illustrating an operation of a terminal providing a first page to a user and obtaining a first input on the first page according to an example embodiment.

Referring to FIG. 3, the terminal 110 may provide a user with the first page including first content related to item information as indicated by reference numeral 310. The first page provided by the terminal 110 may include a UI for obtaining the first input for selecting a purchase of an item. For example, the first page includes a “Buy” button 311, and when there is an input corresponding to the “Buy” button, the terminal 110 may provide a “Buy Now” button 321 and an “Add to Cart” button 322 on the first page as indicated by reference numeral 320.

An input corresponding to the “Buy Now” button 321 may correspond to an example of the first input for selecting a purchase of an item on the first page. The input corresponding to the “Add to Cart” button 322 may correspond to an example of a third input for selecting an item. The terminal 110 that has obtained the first input provides a first payment UI for purchasing the item while maintaining at least a part of the first content, and the terminal 110 that has obtained the third input may provide a second payment UI for purchasing the item on a third page switched from the first page. According to an example embodiment, the terminal 110 that has obtained the third input does not provide the second payment UI on the switched third page immediately, and the second payment UI may be provided upon further obtaining an input corresponding to the “Add to Cart” button 323. Alternatively, according to an example embodiment, the terminal 110 provides a list of items selected by the user upon obtaining an input corresponding to the “Add to Cart” button 323, and may provide the second payment UI when there is a payment request input for the provided list.

According to an example embodiment, the terminal 110 may further include a UI for receiving information on or regarding a purchase quantity of the item on the first page as indicated by reference numeral 324. The purchase quantity information for the item may be included in the first input. As the purchase quantity of the item varies, the purchase amount of the item displayed on the first page may vary. Furthermore, a payment amount displayed on the first payment UI or the second payment UI may be determined based on the purchase quantity of the item.

Depending on the example embodiments, the purchase quantity information for the item may be included in the second input.

FIG. 4 is an exemplary diagram illustrating an operation of a terminal providing a first payment UI while maintaining at least a part of the first content according to an example embodiment.

Referring to FIG. 4, the terminal 110 according to an example embodiment may provide the first payment UI 410 when user information and information of an item corresponding to a first input correspond to a preset condition as indicated by reference numeral 400.

The terminal 110 may provide the first payment UI 410 while maintaining at least a part 420 of the first content. At least a part 420 of the first content may be provided to check the item information. When the terminal 110 provides the first payment UI 410 and maintains at least a part 420 of the first content, the user can check the item to be paid, thereby preventing payment due to an error.

According to an example embodiment, the terminal 110 may display at least a part 420 of the first content and the first payment UI 410 such that at least a part 420 of the first content is not easily identified compared to the first payment UI 410. For example, the terminal 110 may provide at least a part 420 of the first content by shading it to appear dark or by performing a blur process to make it appear blurred.

The first payment UI 410 may include a UI for obtaining a second input. Specifically, the first payment UI 410 may include at least some of a UI 411 for inputting a delivery address, a UI 413 for inputting a payment method, and a UI 415 for proceeding with a payment.

According to an example embodiment, the first payment UI 410 may provide previously stored payment method information included in payment information corresponding to the user, and may further provide previously stored delivery address information depending on the example embodiments. For example, the UI 411 for inputting a delivery address may display previously stored delivery address information, and the UI 413 for inputting a payment method may display previously stored payment method information. In this case, if a change input for the delivery address or payment method is not obtained, the terminal 110 may process a transaction based on the previously stored payment method information, and may process a shipment request and a delivery request based on the previously stored delivery address information. On the other hand, when the second input includes at least one of an input for setting a payment method and an input for setting a delivery address, the terminal 110 processes the transaction according to the changed payment method based on the second input or processes the shipment request and delivery request based on the changed delivery address. Depending on the example embodiments, when the second input includes at least one of an input for setting a payment method and an input for setting a delivery address, the terminal 110 may provide the second payment UI on the second page switched from the first page.

According to an example embodiment, the first payment UI 410 may include a UI 412 for inputting delivery request information. According to an example embodiment, the first payment UI 410 may display the total payment amount 414.

Meanwhile, in an example embodiment, at least one of the UI 411 for inputting a delivery address, the UI 412 for inputting delivery request information, and the UI 413 for inputting a payment method may change the input information based on a slide input in a specific direction. For example, in the case of a user who has entered a plurality of delivery address information, the input delivery address may be sequentially changed through slide input. Therefore, it is possible to change the information for item purchase more easily than changing the related information on or regarding a separate page by entering change. In this case, an icon indicating whether the slide is possible may be additionally displayed.

The UI for payment process 415 may be a UI for obtaining an input for payment process. According to an example embodiment, the input for payment process may correspond to a slide input to a touch pad or a touch screen. According to an example embodiment, the input for the payment process may correspond to a touch or a click on a payment button.

FIG. 5 is an exemplary diagram illustrating an operation of a terminal providing a second payment UI on a second page switched from a first page according to an example embodiment.

Referring to FIG. 5, as indicated by reference numeral 500, the terminal 110 according to an example embodiment may provide a second payment UI for purchasing an item on the second page switched from the first page when user information and item information corresponding to the first input do not correspond to a preset condition or a third input indicating an intention to purchase the item is obtained. According to an example embodiment, the second payment UI may display the interface in more detail compared to the first payment UI, or it may further include content that is not displayed on the first payment UI.

Depending on the example embodiments, even when the second input includes at least one of an input for setting a payment method and an input for setting a delivery address, the terminal 110 may provide the second payment UI. In this case, the second payment UI may display payment method or delivery address information corresponding to the second input. According to an example, when an input corresponding to the “Change” icon of FIG. 4 is received, the terminal 110 may provide the second payment UI. More specifically, if the payment method information and the delivery address information are changed through the slide input in FIG. 4, the corresponding information can be changed while maintaining the corresponding UI. If an input corresponding to the “Change” icon is received, the second payment UI for purchasing the item may be provided in the second page.

FIG. 6 is an exemplary diagram illustrating an operation of a terminal providing a cancellation UI for canceling an input for a payment process according to an example embodiment.

Referring to FIG. 6, as indicated by reference numeral 600, the terminal 110 receiving a second input including an input for proceeding with a payment according to an example embodiment may provide a cancellation UI 610 for canceling an input for proceeding with a payment. The cancellation UI 610 may be provided for a preset time. In the case of the first payment UI, there is a high probability that the user inputs payment due to an error or mistake because it is displayed on the first page. Accordingly, by providing the cancellation UI 610, the terminal 110 may provide the user with an opportunity to cancel the payment input.

When obtaining an input corresponding to the cancellation UI 610, the terminal 110 may cancel the processed transaction. In relation to this, if the terminal 110 has already transmitted a request for shipment and delivery to the first server, the terminal 110 may transmit a request for cancellation of shipment and delivery to the first server. In addition, if the terminal 110 has already transmitted a request for payment of the item sales price to the second server, the terminal 110 may transmit a request to cancel the payment of the item sales price to the second server. If the item sales price has already been paid, a refund may be proceeded with.

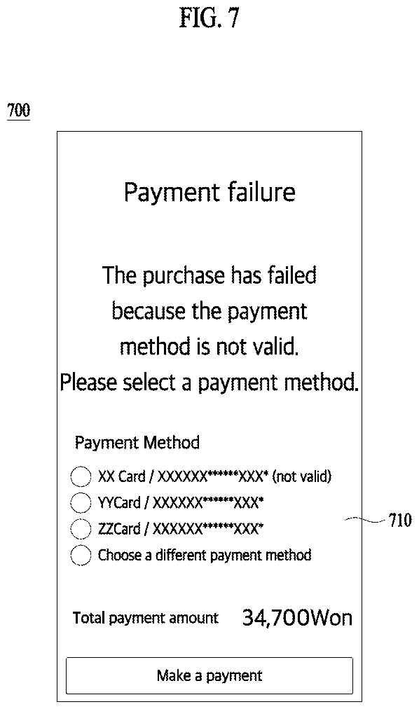

FIG. 7 is an exemplary diagram illustrating an operation of displaying a list of pre-stored payment method information when a terminal fails to process a transaction related to a payment method according to an example embodiment.

Referring to FIG. 7, as indicated by reference numeral 700, when processing of a transaction related to a payment method fails, the terminal 110 according to an example embodiment may display a list 710 of previously stored payment method information. A case in which the transaction processing fails in relation to the payment method may include, for example, a case in which the transaction processing fails because the payment method is invalid. According to an example embodiment, the list 710 of payment method information may further include information indicating that the payment method is not valid in relation to at least some of the payment methods. Alternatively, the list 710 of payment method information may not include an invalid payment method.

The terminal 110 may provide the list 710 of payment method information on or regarding the third page switched from the first page. The third page may further include information notifying that payment has failed.

The terminal 110 may further provide a UI capable of obtaining a user input in relation to the list 710 of payment method information. When receiving an input corresponding to a specific payment method included in the list of previously stored payment method information, the terminal 110 may process a transaction based on the specific payment method.

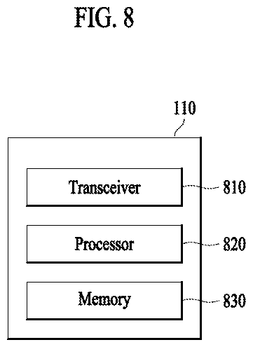

FIG. 8 is an exemplary diagram of a configuration of a terminal for processing item sales information according to an example embodiment.

Referring to FIG. 8, the terminal 110 includes a transceiver 810, a processor 820, and a memory 830. The terminal 110 is connected to the electronic device 120, the first server, the second server, and other external devices through the transceiver 810, and may exchange data.

The processor 820 may include at least one of the devices described above with reference to FIGS. 1 to 7, or may perform at least one method described above with reference to FIGS. 1 to 7. The memory 830 may store information for performing at least one method described above with reference to FIGS. 1 to 7. The memory 830 may be a volatile memory or a nonvolatile memory.

The processor 820 may control the terminal 110 for executing a program and providing information. The code of a program executed by the processor 820 may be stored in the memory 830.

In addition, the terminal 110 of an example embodiment may include a UI capable of providing information to a user.

Meanwhile, some example embodiments of the present disclosure have been described in this specification and drawings. Though specific terms have been used, these terms are used in a general sense only for an easy description of the technical content of the present disclosure and a better understanding of the present disclosure, and are not intended to limit the scope of the present disclosure. It will be clear to those skilled in the art that, in addition to the embodiments disclosed here, other modifications based on the technical idea of the present disclosure may be implemented.

The electronic device or terminal according to the above-described embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-Access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present embodiment can be represented by functional block configurations and various processing steps. These functional blocks may be implemented with various numbers of hardware or/and software configurations that perform specific functions. For example, the embodiment may employ an integrated circuit configuration such as memory, processing, logic, look-up table, or the like, capable of executing various functions by control of one or more microprocessors or other control devices. Similar to that components can be implemented with software programming or software elements, this embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described embodiments are merely examples, and other embodiments may be implemented within the scope of the claims to be described later.

1. A method operable by an electronic apparatus to process item sales information, the method comprising:
receiving, via a communication hardware of the electronic apparatus, a request transmitted from a user terminal of a user;
generating a first page comprising a first content related to item information of an item related to the request;
receiving a first input for purchase of the item via the first page, the first page displayed on the user terminal;
determining a first preset condition from a user reliability index based on a number of purchases, a purchase cancellation rate, and a payment failure rate of the user wherein the first preset condition is met in response to the user reliability index meeting a threshold value;
determining a second preset condition from the item information, wherein the second preset condition comprises:
the item not being subject to installment payments; and
tax declaration not being requested for the purchase of the item;
in response to the first preset condition and the second preset condition being satisfied, generating a first payment user interface (UI) for purchasing the item on the user terminal while maintaining at least a portion of the first content displayed on the user terminal, the first payment UI and the maintained portion of the first content being in lieu of a second page for setting a payment method; and
processing a transaction related to the purchase of the item based on a second input to the first payment UI and payment information corresponding to the user.

2. The method of claim 1 further comprising: receiving user information associated with the user from the user terminal, the user information comprising the number of purchases, the purchase cancellation rate, and the payment failure rate of the user.

3. The method of claim 1, further comprising:
in response to at least one of the first preset condition or the second preset condition not being satisfied, generating the second page comprising a second payment UI for purchasing the item, the second page different from the first page.

4. The method of claim 1, wherein determining the second preset condition for purchase of the item comprises a payment price of the item meeting a threshold condition.

5. The method of claim 1, wherein the first payment UI comprises at least one UI for inputting a payment method, a UI for inputting a delivery address, and a UI for processing a payment.

6. The method of claim 5, wherein the first input and an input received via the UI for processing a payment are different types of inputs.

7. The method of claim 1, wherein the second input comprises at least one of: an input for setting the payment method, an input for setting a delivery address, or an input for processing a payment, and wherein:
in response to determining that the second input is of a first type of input, changing at least one of a payment method setting and a delivery address setting on the first page; and
in response to determining that the second input is of a second type of input, changing at least one of the payment method setting and the delivery address setting on the second page.

8. The method of claim 1, further comprising:
providing a UI for canceling the payment process for a preset period of time when the second input includes an input for processing a payment.

9. The method of claim 1, wherein a request for shipment of the item is provided to a first server in accordance with processing of the transaction.

10. The method of claim 1, wherein the payment information corresponding to the user comprises previously stored payment method information.

11. The method of claim 10, wherein the processing of the transaction related to the purchase of the item comprises:
in response to determining that the second input does not include an input for setting a payment method, processing the transaction for the item based on the previously stored payment method information; and
in response to determining that the second input includes an input for setting the payment method, processing the transaction for the item based on the payment method set by the second input.

12. The method of claim 10, further comprising:
in response to determining that the processing of the transaction fails in relation to the payment method, displaying a list of the previously stored payment method information; and
in response to receiving an input corresponding to a specific payment method included in the list of previously stored payment method information, processing the transaction based on the specific payment method.

13. The method of claim 1, further comprising:
determining that the second input comprises an input for providing a payment method or a delivery address; and
in response to the determining that the second input comprises an input for providing a payment method or a delivery address, generating a second payment UI for purchasing the item on the second page different from the first page.

14. The method of claim 1 further comprising:
receiving a third input for the item; and
in response to the receiving the third input, generating a third page comprising a second payment UI for purchasing the item, the third page different from the first page,
wherein the third page comprises information associated with an item list comprising items selected by the user; and
wherein payment for at least one item in the item list is processed based on an input received via the second payment UI for purchasing the item.

15. The method of claim 1, wherein at least one of the first input and the second input comprises purchase quantity information for the item.

16. A non-transitory computer-readable recording medium storing thereon computer-readable instructions that, when executed by a processor of an electronic apparatus, cause the processor to:
receive, via a communication hardware of the electronic apparatus, a request transmitted from a user terminal of a user;
generate a first page comprising a first content related to item information of an item related to the request;
receive a first input for purchase of the item via the first page, the first page displayed on the user terminal;
determine a first preset condition from a user reliability index based on a number of purchases, a purchase cancellation rate, and a payment failure rate of the user, wherein the first preset condition is met in response to the user reliability index meeting a threshold value;
determining a second preset condition from the item information, wherein the second preset condition comprises:
the item not being subject to installment payments; and
tax declaration not being requested for the purchase of the item;
in response to the first preset condition and the second preset condition being satisfied, generate a first payment user interface (UI) for purchasing the item on the user terminal while maintaining at least a portion of the first content displayed on the user terminal, the first payment UI and the maintained portion of the first content being in lieu of a second page for setting a payment method; and
process a transaction related to the purchase of the item based on a second input to the first payment UI and payment information corresponding to the user.

17. An electronic apparatus for processing item sales information, the apparatus comprising:
a transceiver;
a memory in which instructions are stored; and
a processor,
wherein the processor is connected to the transceiver and the memory and configured to:
receive, via the transceiver, a request transmitted from a user terminal of a user;
generate a first page comprising a first content related to item information of an item related to the request;
receive a first input for purchase of the item via the first page, the first page displayed on the user terminal;
determine a first preset condition from a user reliability index based on a number of purchases, a purchase cancellation rate, and a payment failure rate of the user, wherein the first preset condition is met in response to the user reliability index meeting a threshold value;
determine a second preset condition from the item information, wherein the second preset condition comprises:
the item not being subject to installment payments; and
tax declaration not being requested for the purchase of the item;
in response to the first preset condition and the second preset condition being satisfied, generate a first payment user interface (UI) for purchasing the item on the user terminal while maintaining at least a portion of the first content displayed on the user terminal, the first payment UI and the maintained portion of the first content being in lieu of a second page for setting a payment method; and
process a transaction related to the purchase of the item based on a second input to the first payment UI and payment information corresponding to the user.
